(19) United States
(12) Patent Application Publication
(10) Pub. No.: US 2014/0297259 A1
(43) Pub. Date: Oct. 2, 2014

(54) APPARATUS AND METHOD FOR WIRELESSLY TRIGGERING THE SIMULTANEOUS PLAYING OF MULTIPLE LANGUAGE TOUR COMMENTARIES IN A GROUP TOUR ENVIRONMENT

(71) Applicants: Jonathan KRUSE, Mt Roskill (NZ); Shaun O'DONNELL, St Lukes (NZ)

(72) Inventors: Jonathan KRUSE, Mt Roskill (NZ); Shaun O'DONNELL, St Lukes (NZ)

(21) Appl. No.: 14/226,392

(22) Filed: Mar. 26, 2014

(30) Foreign Application Priority Data
Mar. 27, 2013 (NZ) 608758

(51) Int. Cl. G06F 17/28

(52) U.S. Cl. CPC G06F 17/289
USPC 704/8

(57) ABSTRACT

A system and method for providing simultaneous multiple language tour commentary in a group tour environment. The system and method wirelessly triggers the simultaneous playing of multiple language tour commentaries in a group tour environment using a Master Controller Device to trigger the playing of location specific audio commentaries stored on Personal Wireless Receiver Devices worn by participants of a group tour who are moving through a geographic area.

### CROSS-REFERENCE TO RELATED APPLICATIONS

This application claims priority to New Zealand Patent Application No. 608758 filed Mar. 27, 2013 the disclosure of which is incorporated in its entirety by reference herein.

### TECHNICAL FIELD

The apparatus and methodology relates to apparatus and a method for the delivery of simultaneous multiple language audio commentary to wearers of receivers who are moving through or within a geographic area, attraction, exhibit, museum, historical landmark or place as a group tour by any method of travel, examples of which are walking, automobile, bus, tour coach, train, motorhome, bicycle, scooter, motorbike or air or marine craft or combination of travel methods thereof.

### BACKGROUND

Tour-guide systems such as those used in small group tours rely on a tour guide with a microphone to provide the tour commentary. Small group tours frequently contain multiple nationalities, some of whom may not be fluent in the language of tour guide and therefore do not understand the tour guide commentary.

Individual personal tour-guide systems utilised in art galleries and museums and are not designed for group tour environments or vehicle-based tourism applications such as tour buses, trains, air or marine craft environments.

Passengers on tour buses, trains, air or marine craft tourism are provided with commentary either by a tour guide or the vehicle driver using a microphone and broadcasting through the vehicles public address system.

Multilingual systems used in tour buses, air or marine craft tourism are either hardwired into the vehicle where headphones are plugged into individual seatback controllers or wireless systems that broadcast via a continuous stream of RF data. Hardwired systems restrict the passengers' ability to move freely about a vehicle and continue to receive a commentary; wireless systems are subject to interference from other transmission sources which results in intermittent audio reception and are not suitable for use in tourism environments where a number of tour operators may be operating simultaneously.

The apparatus and methodology addresses the requirement for the manual or automated delivery of tour commentary simultaneously in multiple languages for group tours moving through a geographic area, attraction, exhibit, museum, historical landmark or place by any method of travel including walking or vehicle or combination of travel methods thereof;

The apparatus and methodology addresses the need for a wireless delivery of tour commentary simultaneously in multiple languages for a group tour moving through a geographic area, attraction, exhibit, museum, historical landmark or place that is not subject to broadcast interference or requires the apparatus to be hardwired into a vehicle or exhibit.

### SUMMARY

In broad terms the invention is apparatus and a method for wireless automatic or manual provision of location specific audio commentary in multiple languages simultaneously to the wearer(s) of headphones and receivers who are moving through a geographic area, attraction, exhibit, museum, historical landmark or place as a group tour by any method of travel or combination of travel methods thereof.

In GPS mode, the master controller processor uses data streamed from the GPS receiver to continuously monitor the location of the master controller as it moves through or within a geographic area.

The master controller processor continually assesses the location data sentences received from the GPS receiver and checks whether the location data sentences correlate to series of pre-defined geographic locations stored as a location database within the master controllers' digital memory.

When a relevant geographic location is detected by the master processor, the master processor instructs the master controllers RF transmitter to digitally broadcast a burst of small encoded instruction packets via the RF transmitter to all of the receivers worn by members of the group.

In manual mode, a tour guide uses the device keypad on the master controller to select and then activate the playing of the selected audio commentary by broadcasting a burst of small encoded instruction packets via the master controllers RF transmitter to all of the receivers worn by members of the group.

Regardless of master controller mode each receiver processor decodes the encoded instruction packet received from the master controller and first checks the language that has been pre-selected by the wearer on the receivers' keypad and then locates the digital audio file specified in the encoded instruction packet on the receivers' digital memory storage for transfer to the receivers digital audio processor for decoding into analogue audio which is then routed to the receivers headphone output jack and on to the headphones worn by the wearer.

The current methods for providing simultaneous multiple language tour commentary in a group tour environment is for either a tour guide with a microphone to provide tour commentary, or in vehicle based tour environments, for a multi-channel player equipped with multiple RF transmitters to broadcast a continuous stream of audio commentary in either digital or analogue format to wearers of RF receivers tuned to the frequency for their language or for a multi-channel player to be hard-wired into the vehicle in conjunction with seatback controllers where passengers can plug in headphones and select the applicable channel for their language. The limitations of these technologies and methodology for providing simultaneous multi-lingual commentary are that a tour guide can only provide a single language and therefore multiple nationalities travelling as part of the same group who are not fluent in the language of tour guide do not receive a commentary.

Multi-channel RF systems that broadcast a continuous stream of data are subject to interference from other RF sources transmitting on the same or very close frequencies and an ever decreasing number of unused RF frequencies on which to transmit; hard-wired systems will not work in environments where tour group members move around such as in group guided walking attractions and vehicle tourism applications that often include short walking tours as part of their vehicle tourism experience. The proposed apparatus and methodology addresses the limitations of all current tour guide technologies by using a master controller that contains a PCB mounted master processor that controls a digital radio frequency (herein referred to as “RF”) transmitter/receiver, digital memory storage, a keypad, optional GPS receiver and rechargeable batteries. An apparatus and a method is disclosed for providing delivery of an unlimited number of multiple language audio commentaries simultaneously to wearers of headphones connected to a receiver that contains a PCB populated with a digital radio frequency (herein referred to as “RF”) receiver, digital memory storage, a keypad, rechargeable batteries, who are moving through or within a geographic area as a group by way of by any method of travel examples of which are walking, automobile, bus, tour coach, train, motorhome, bicycle, scooter, motorbike or air or marine craft (herein referred to as “vehicle”).

In GPS mode, the master controller processor samples the GPS receiver to continuously monitor the location of the master controller. The master controller processor continually assesses the location data strings received from the GPS receiver and checks whether the location data strings correlate to a geographic location from a location database stored within the master controllers' digital memory. When a relevant geographic location is detected by the master processor, the master processor instructs the RF transmitter to broadcast a short burst of encoded instruction packets to the receivers worn by the wearers, the instructions instruct the receivers to decode and play a digital audio file stored on the receivers digital memory in the language that has been selected by the wearer on the receivers keypad. A digital audio file is sent to the receivers digital audio processor for decoding into analogue audio and through the receivers headphone output jack and on to the headphones worn by the wearer. In manual mode, a tour guide uses the device keypad on the master controller to select and then activate the playing of the selected commentary by broadcasting a short burst of encoded instruction packets from the master controller to the receivers worn by the wearers.

### BRIEF DESCRIPTION OF THE DRAWINGS

Preferred forms and method of the invention will be further described with reference to the accompanying drawings by way of example only and without intending to be limiting, wherein:

FIG. 1 is a block diagram showing the major internal components of the master controller where either the inbuilt GPS receiver provides the master processor with GPS location data to enable the internal master processor to check the GPS location data against a database of pre-defined geographic locations stored in the master controller memory and if a correlation is confirmed or alternatively the master controller keypad is manually used the master processor transmits a burst of encoded instruction packets via the inbuilt RF transmitter to the receivers worn by members of the tour group.

FIG. 2 is a diagram explaining the burst of encoded instruction packets that are transmitted by the RF transmitter.

FIG. 3 is a block diagram showing the major internal components of the wireless receivers worn by members of the tour group that receive encoded instruction packets via the inbuilt RF receiver which are sent to the receivers processor for verification against the language and tour pre-set on the receiver and then selecting the specified digital audio file from the database of digital audio files stored in the receivers internal memory to be decoded by the audio processor and sent to the headphones plugged into the receiver.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

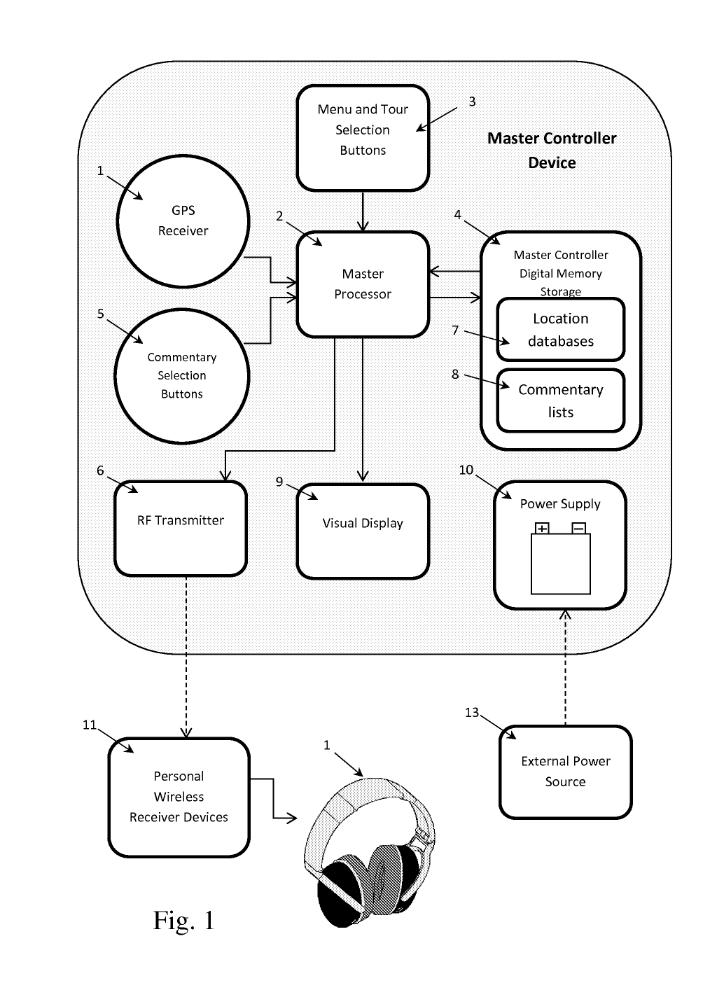

FIG. 1 is a block diagram that generally depicts the major components of the Master Controller Device utilized in the multilingual wireless tour commentary system. The menu and tour selection buttons (3) are used in conjunction with the visual display (9) to set the master processor (2) to operate in automated GPS mode where the operator selects one of the location databases (7) or manual commentary selection mode where the operator selects a particular list of commentaries (8).

Operating in automated GPS mode the master processor continuously samples a stream of location data from the GPS receiver (1). The sampled location data is compared to a previously selected database of locations (7) that are stored on the digital memory storage (4). Upon detecting a match between the current geographical location supplied by the GPS receiver (1) and a geographical location stored in the location database (7) the master processor will instruct the RF transmitter (6) to send a short burst of encoded instruction packets to any personal wireless receiver devices (11) within range of the RF transmitter.

Operating in manual commentary selection mode the tour leader uses the commentary selection buttons (5) in conjunction with the visual display (9) to select a commentary to play. Upon selection of a commentary the master processor will instruct the RF transmitter (6) to send a short burst of encoded instruction packets to any personal wireless receiver devices (9) within range of the RF transmitter.

Visual display (30) on the master controller may be in several forms or in combination. Visual display may be provided by liquid crystal display (LCD), organic light emitting display (OLED), vacuum fluorescent display (VFD) or any forms of mobile display technology that may be developed in the future.

The RF transmitter (6) is preferably a digital radio frequency transmitter that operates in the industrial, scientific and medical (ISM) radio band which permits licence free broadcasts on varying frequencies throughout the world.

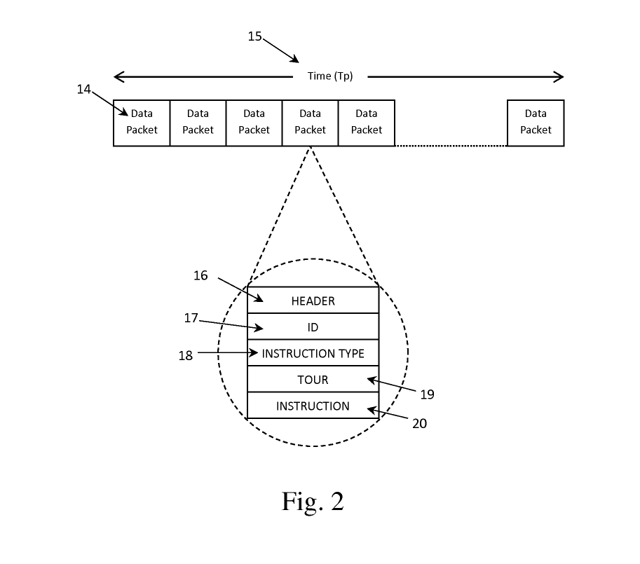

FIG. 2 describes in detail the short burst of encoded instruction packets that are sent by the master controller device and received by the personal wireless receiver devices. The burst of packets consists of a number of identical packets (14) repeatedly broadcast within a time period (15) which is typically less than 1 second. Transmitting the same identical packet multiple times mitigates the possibility of any one packet getting interfered with and failing to instruct an individual receiver.

Each individual encoded instruction packet contains several core fields of information as follows. The packet header field (16) is a proprietary code number that identifies this packet as belonging to the multilingual wireless system. The Packet ID field (17) is a unique number that is incremented each time a distinct instruction is sent by the master controller device and prevents the receiver acting on the same instruction more than once. The instruction type field (18) is a code number that identifies what type of instruction is being sent and defines the way the receiver will act. The instruction data field (20) contains data to supplement the instruction type field (18). The standard encoded instruction packet contains a code in the instruction type field (18) that tells the receiver it is to play a digital audio file and the accompanying instruction data field (20) contains the name of the digital audio file to play. The tour field (19) contains a code that is unique to the particular tour that is being run by the operator and is necessary to prevent multiple tours operating in the same geographic location from instructing receivers on a different tour.

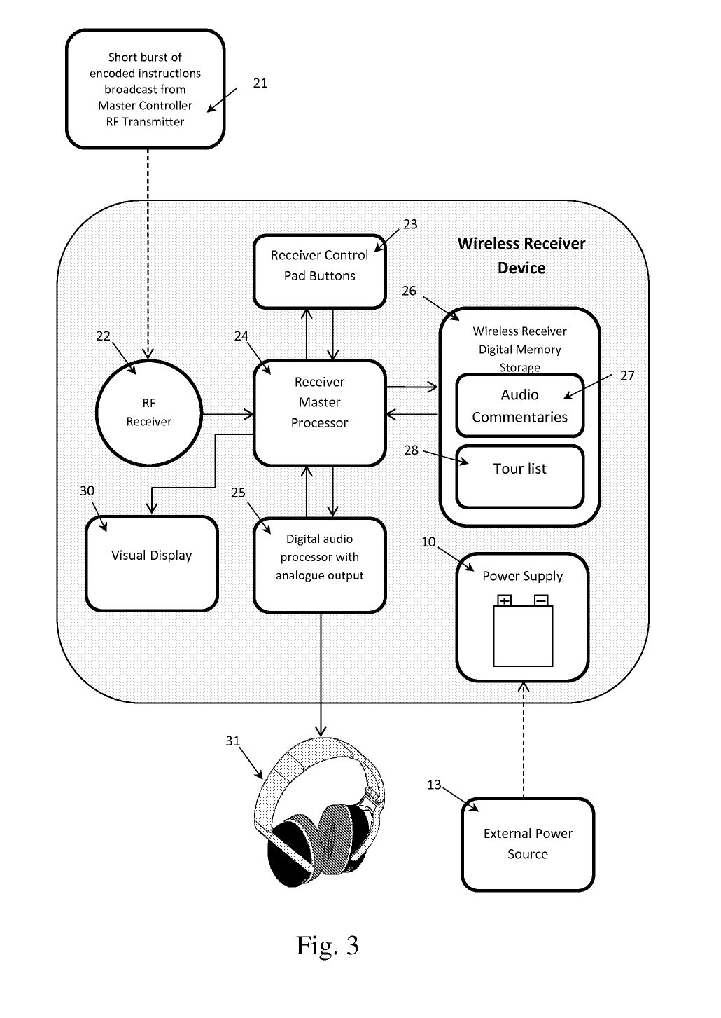

FIG. 3 is a block diagram that generally depicts the major components of the wireless receiver device that is responsible for delivering audio content to the wearer(s) of the device. The wearer of the device uses the receiver control pad buttons (23) in conjunction with the visual display (30) to firstly select a language and then secondly to select a tour from a list of tours (28) stored on the wireless receiver digital memory storage (26). Following the selection of a language and tour the master processor waits to receive instructions from the master controller device.

Encoded instruction packets sent by the master device (21) are received by the RF receiver (22) built into the wireless receiver device which in turn passes the packets to the receiver master processor (24). The receiver master processor decodes the message checking each of the fields in the packet, first checking that the header (16) to confirm that the message is valid for the system then checking packet is a new instruction by confirming the packet ID (17) has not been received before. Next the tour field (19) is validated against the tour set by the wearer(s) and finally acting on the instruction as indicated by the instruction type (18) and instruction data fields (20).

An instruction to play an audio commentary with the name specified in the instruction data field (20) of the encoded packet would cause the receiver master processor to stream the contents of the digital audio file (27) stored on the wireless receiver digital memory storage (26) in the language selected earlier by the wearer to the digital audio processor (25). The digital audio processor (25) converts the digital file into an analogue audio signal that is output via a headphone connector to headphones (31) worn by the wearer of the wireless receiver device.

The RF receiver (22) is preferably a digital radio frequency transmitter that operates in the industrial, scientific and medical (ISM) radio band which permits licence free broadcasts on varying frequencies throughout the world.

The Master Controller and Wireless receiver device power supply (10) is internal to the devices and contains voltage regulation functions, energy storage; preferably in the form of a rechargeable battery and battery charging functions. In addition to charging the internal energy storage the external power supply source (13) can be optionally used to power the device.

Digital memory storage on the master controller (4) and the wireless receiver device (26) may be in several forms or in combination. Internal storage may be provided on RAM, Flash Memory or any form of digital storage including removable media currently available such as SD Card, Micro SD, TF Card or any forms of solid state or removable media that may be developed in the future.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for wirelessly triggering the simultaneous playing of multiple language tour commentaries in a group tour environment using a Master Controller Device to trigger the playing of location specific audio commentaries stored on Personal Wireless Receiver Devices worn by participants of a group tour who are moving through a geographic area of by any method of travel, where the Master Controller Device contains a master processor that controls a GPS receiver, an RF (radio frequency) transmitter, digital memory storage, visual display, rechargeable power supply and a keypad used to access databases of locations, audio commentary lists, safety message file names and menu options within the master controllers digital memory storage and set the instruction parameters that the Master Controller Device processor instructs the RF Transmitter to broadcast as a short burst of encoded instruction packets to the Personal Wireless Receiver Devices that contain an RF receiver, RF receiver master processor, visual display, digital memory storage, rechargeable power supply, digital audio processor with analogue output and a keypad used to access data stored on the digital memory storage including a database of tour options, a database of language options and a database of digital audio files pertaining to each tour option and language option, and where upon receiving an encoded instruction to play a digital audio file the Personal Wireless Receiver Device master processor verifies the language and tour pre-set on the Personal Wireless Receiver Device and then locates the digital audio file specified by the file name in the encoded instruction from the database of files stored in the Personal Wireless Receiver Device internal memory and sends that digital audio file to the Personal Wireless Receiver Device digital audio processor where it is converted to an analogue audio signal which is output to the headphone connector into which a set of headphones are plugged to enable the participants of a group tour wearing the Personal Wireless Receiver Devices to hear the audio commentary in their selected language option.

2. The system for wirelessly triggering the simultaneous playing of multiple language tour commentaries in a group tour environment using a Master Controller Device to automatically trigger the playing of location specific audio commentaries stored on Personal Wireless Receiver Devices worn by participants of a group tour who are moving through a geographic area of by any method of travel and further to claim 1, the master controller device sends a short burst of encoded instructions over radio frequency as a method for eliminating the interference from other transmission sources that can occur when transmitting a continuous stream of audio data.

3. The system for wirelessly triggering the simultaneous playing of multiple language tour commentaries in a group tour environment using a Master Controller Device to trigger the playing of location specific audio commentaries stored on Personal Wireless Receiver Devices worn by participants of a group tour who are moving through a geographic area of by any method of travel and further to claim 2 where the Master Controller Device can be set to automatically send encoded instructions to the Personal Wireless Receiver Devices by using the master controllers internal master processor to continually assess the location data strings streamed from the inbuilt GPS receiver that is continuously monitoring the location of the Master Controller Device and checking whether the location data strings correlate to a latitude/longitude location stored within the Master Controller Device digital memory and when a relevant latitude/longitude location is detected by the master processor, the master processor instructs the RF Transmitter to broadcast a short burst of encoded instruction packets to any Personal Wireless Receiver Devices within RF range instructing them to locate and play the digital audio file specified in the encoded instruction from digital memory storage located in the Personal Wireless Device.

4. The system for wirelessly triggering the simultaneous playing of multiple language tour commentaries in a group tour environment using a Master Controller Device to trigger the playing of location specific audio commentaries stored on Personal Wireless Receiver Devices worn by participants of a group tour who are moving through a geographic area of by any method of travel and further to claim 3, the Master Controller Device can be set to manually send encoded instructions to the Personal Wireless Receiver Devices by using the master controllers keypad to select the required commentary file name from the database of commentary file names and once selected instruct the RF Transmitter to broadcast a short burst of encoded instruction packets to any Personal Wireless Receiver Devices within RF range instructing them to locate and play the digital audio file specified in the encoded instruction from digital memory storage located in the Personal Wireless Device.

5. The system for wirelessly triggering the simultaneous playing of multiple language tour commentaries in a group tour environment using a Master Controller Device to automatically trigger the playing of location specific audio commentaries stored on Personal Wireless Receiver Devices worn by participants of a group tour who are moving through a geographic area of by any method of travel and further to claim 4, the Master Controller Device digital storage memory contains a database of locations (tour options) that are selectable via the Master Controller Tour and Menu Selection Buttons to enable the Master Controller Device to be utilised on different tour options and by the selecting the required database of locations from a list of the database locations stored within the Master Controller Device digital storage memory using the Master Controller Device keypad, the Master Controller Device broadcasts only the encoded instructions relevant to the selected tour option to the Personal Receiver Devices.

6. The system for wirelessly triggering the simultaneous playing of multiple language tour commentaries in a group tour environment using a Master Controller Device to automatically trigger the playing of location specific audio commentaries stored on Personal Wireless Receiver Devices worn by participants of a group tour who are moving through a geographic area of by any method of travel and further to claim 5, the Personal Wireless Receiver Devices digital storage memory contains a database of tour options (tour list) that are selectable via the Personal Wireless Receiver Devices keypad to enable the Personal Wireless Receiver Devices to be utilised on different tour options and by the selecting the required tour from the database of tours (tour list) stored within the Personal Wireless Receiver Devices digital storage memory using the Personal Wireless Receiver Devices keypad, the Personal Wireless Receiver Devices recognises only the encoded instructions relevant to the selected tour broadcast by the Master Controller Device.

7. The system for wirelessly triggering the simultaneous playing of multiple language tour commentaries in a group tour environment using a Master Controller Device to automatically trigger the playing of location specific audio commentaries stored on Personal Wireless Receiver Devices worn by participants of a group tour who are moving through a geographic area of by any method of travel and further to claim 6, using the Personal Wireless Receiver Devices control pad buttons to select the required language in which to hear the Audio Commentaries stored on Personal Wireless Receiver Devices digital storage memory.
